(19) United States
(12) Patent Application Publication
(10) Pub. No.: US 2002/0075011 A1
(43) Pub. Date: Jun. 20, 2002

(54) Methods and system for collecting information on operating state

(76) Inventors: Markku Kauko, Lahti (FI); Heikki Pienisaari, Mantsala (FI)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/014,748

(22) Filed: Oct. 26, 2001

(30) Foreign Application Priority Data
Oct. 26, 2000 (FI) 20002354

(51) Int. Cl. H01H 31/02

(52) U.S. Cl. 324/556

(57) ABSTRACT

The invention relates to a method and a system for collecting information on the operating state from several devices connected in parallel to the same electric circuit, e.g. from safety lights connected to the same array of safety lights, each of the devices being provided with members for receiving an enquiry about the operating state of the device via the electric circuit from a testing unit and for sending a message indicating the information on the operating state to the testing unit via the electric circuit in response to the enquiry sent from the testing unit. According to the invention, the method comprises steps where the testing unit sends a common enquiry about the operating state of the devices to all members arranged in connection with said devices as at least one pulse-like change in the voltage supplied to the devices via the electric circuit, and the members send their response to the testing unit as a current pulse after a period specific to each device from the pulse change in the supply voltage.

### FIELD OF THE INVENTION

The invention relates to a method and system for collecting information on the operating state from several devices connected in parallel to the same electric circuit, e.g. from safety lights connected to the same array of safety lights, each of the devices being provided with members for receiving an enquiry about the operating state of the device from a testing unit via the electric circuit and for sending a message indicating the information on the operating state to the testing unit via the electric circuit in response to the enquiry received from the testing unit.

A state monitoring system particularly for a signal light and safety light system similar to the one described above is known from Finnish patent 86024. In the system described in this publication, a separate unit which comprises a sensor for measuring the illumination level of the light is arranged close to each light. The unit also has a specific identifying code. The lighting unit is arranged to inform the central processing unit of the measurement value of its sensor after the lighting unit has received the identifying code from the central processing unit. Thus, the central processing unit has to enquire the measurement value of each sensor separately and send a specific identifying code to each lighting unit. Systems of this kind which can not only indicate the fact that the lighting unit has gone out but can also indicate a decrease in the illumination level of the lighting unit have a rather complicated structure and are thus expensive.

Safety lights are not usually checked and serviced regularly enough, partly due to the high price of the automatic testing systems described above and due to the lack of checks by authorities and high maintenance costs. According to the current regulations, safety lights should be checked four times a year. In the near future, however, the regulations will be amended to the effect that a check should be carried out once a month.

### BRIEF DESCRIPTION OF THE INVENTION

In view of the above, there is a need for an affordable method which is applicable to the existing safety light systems and a system for testing the working order of safety lights. The object of the present invention is to provide a method and a system for collecting information on the operating state from several devices connected in parallel to the same electric circuit, e.g. from safety lights connected to the same array of safety lights. A particular object is to provide a method and a system which enable frequent checks of safety lights and can be utilized for converting the existing safety light systems into systems that can be tested automatically without considerable conversion costs.

The above-mentioned objects are achieved with the method of the invention, which is characterized in that it comprises steps where the testing unit sends a common enquiry about the operating state of the devices to all members arranged in connection with the devices as at least one pulse-like change in the voltage supplied to the devices via the electric circuit and the members send their response to the testing unit as a current pulse after a certain period specific to each device from the pulse change in the supply voltage. In other words, the basic idea of the invention is that the enquiry is sent simultaneously to all devices aware of the operating state of the lights as a simple pulse change in the supply voltage and each member possibly also responds to this enquiry with a simple pulse, which it, however, sends within the timeslot reserved for it, which enables identification of the source of the response.

In the simplest embodiment of the invention, which may thus also be the most advantageous embodiment, only the members in association with a device having a pre-determined operating state send a response to the testing unit. Even though these response pulses may include information other than ON/OFF information, in the simplest embodiment it is possible to arrange only the members in connection with a device having a pre-determined operating state of two feasible operating states of the device to send a response to the testing unit. Thus, in the simplest version only the members connected to a safety light in working order send a response pulse. Since a specific timeslot during which a light may send its response pulse is reserved for each light, it can be concluded from the missing response pulses which lights are defective.

As stated above, the invention also relates to a system for collecting information on the operating state from several devices connected in parallel to the same electric circuit, e.g. from safety lights connected to the same array of safety lights. This system is characterized in that the enquiry about the operating state of the devices sent by the testing unit comprises at least one pulse-like change in the voltage supplied to the devices via the electric circuit, the change being common to all the members arranged in connection with the devices, and each of the members comprises means for sending a current pulse to the testing unit in response to the pulse change in the supply voltage after a period specific to each member after the pulse change was received. According to the above, it is advantageous that each of the members is arranged to send its response only if the device arranged in connection with it has a pre-determined operating state.

According to a preferred embodiment, the means for setting the delay period specific to each member comprises a microprocessor and a digital setting unit connected to it, such as a DIP switch.

### BRIEF DESCRIPTION OF THE FIGURES

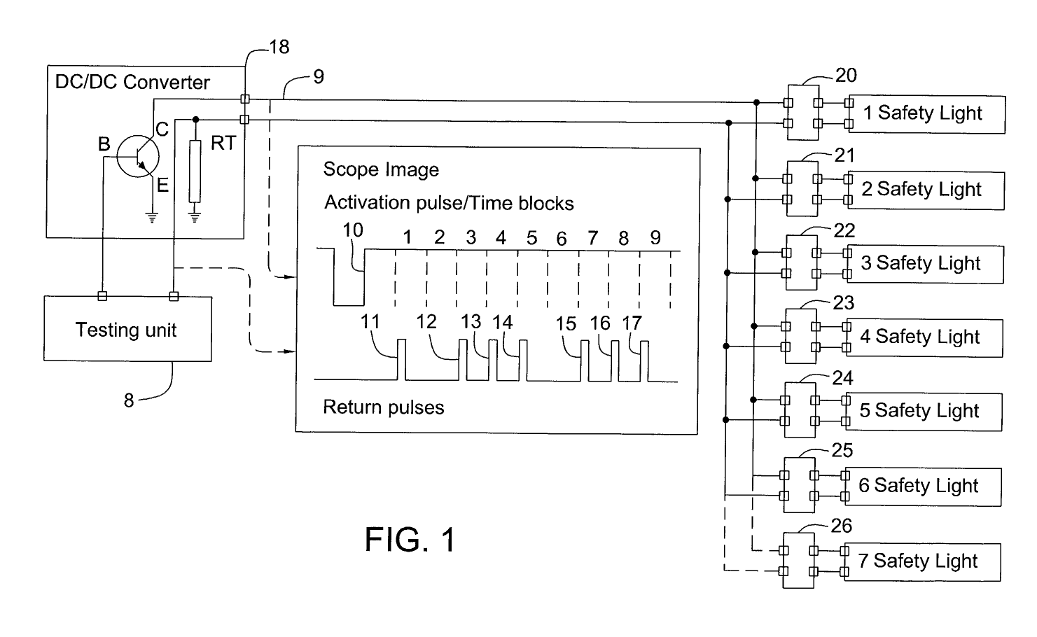

In the following, the method and system of the invention for collecting information on the operating state from several devices connected in parallel to the same electric circuit, e.g. from safety lights, will be described with reference to FIG. 1, which schematically illustrates some lights of one safety light array and units related to them for implementing the system according to the invention.

### DETAILED DESCRIPTION OF THE INVENTION

FIG. 1 schematically illustrates part of a safety light array, which comprises several safety lights connected in parallel. These safety lights are denoted by reference numbers 1 to 7. As shown in FIG. 1, the number of the safety lights in the array may naturally be larger. These safety lights are supplied by an electric circuit 9. A safety light centre is used as the supply source. FIG. 1 shows only part of this centre, i.e. a DC/DC converter 18. Normally the safety light centre is arranged to supply AC voltage to each safety light array. The safety light centre also comprises a battery for any breaks in the alternating voltage. The voltage of the battery is increased to the desired level, e.g. 230 V, by means of the converter 18.

The simplest way for implementing the method according to the invention is to first force the safety light array to battery drive, in which case the DC/DC converter 18 supplies a DC voltage of 230 V to the electric circuit 9. If the operation of the safety lights is to be tested, a pulse-like change is caused in the voltage of the DC supply by a testing unit 8. This pulse-like change may be caused e.g. by dropping the direct voltage received by the safety lights via the electric circuit 9 for a while, e.g. 100 ms, e.g. by five volts. Members, labelled 20 to 26, that detect the pulse-like change in the supply voltage of the safety light are arranged in connection with each safety light 1 to 7, in practice next to the lamp or the like in the light. As generally shown, each member 20 to 26 is electrically coupled to electric circuit 9 and to its corresponding safety light 1 to 7. The activation pulse activates the members arranged in connection with each safety light and each sends a response message as a low current pulse at a specific time one after another. As shown in FIG. 1, an activation pulse is marked with reference numeral 10 and it is shown as a spike-like short drop in the voltage of the electric circuit 9.

The activation pulse 10 is followed by time blocks, which are numbered up to nine in the figure. As stated above, each safety light, or more precisely, the member connected to it, is arranged to give a return pulse as a current pulse after a delay period specific to each light after the activation pulse was detected. These return pulses are marked with reference numbers 11 to 17. The figure shows that these pulses occurred in timeslots 1, 3, 4, 5, 7, 8 and 9. Thus, no return pulse was received in timeslots 2 and 6. In the simplest embodiment of the invention this means that the lights 2 and 6 are not in working order.

The means related to the members 20 to 26 arranged in connection with each safety light 1 to 7 for setting a delay period specific to the members may consist of a conventional delay circuit, such as an RC delay circuit. A microprocessor and a digital setting unit, such as a DIP switch, connected to it for setting the delay period specific to the unit in question directly as a digital code provide a more reliable alternative, which is considerably easier to code.

The above-mentioned members in connection with the lights may receive information on the working order of the safety lights in various ways. For example, it is possible to use a prior art sensor which measures the illumination level of the light and detects whether the safety light emits light. The following method is also feasible in connection with this kind of measurement: the members in question are arranged to provide a current pulse comparable to the measured illumination level in response to an enquiry or activation pulse received from the testing unit. In that case information other than whether the light is in working order could be obtained on the operation of the light. This information could be transmitted as a digitally encoded serial signal.

In the simplest and most advantageous embodiment of the invention ON/OFF information on whether the light is in working order or not is sufficient. Furthermore, a completely identical current pulse which is given only when the light is in working order can be used as this information for all lights. When the light is defective, no pulse is given and thus the defect in a certain light appears from the lack of a response pulse in the timeslot reserved for the light in question. Commercial safety lights are often provided with a signal output, the state of which indicates whether the safety light is in working order or not. A signal output of this kind is intended to be connected to an automatic control system, which typically uses a separate electric circuit for transmitting this information. In the method and system of the invention there is no need for a separate electric circuit but the information is transmitted via current supply wires of the lights. Thus, the information on the working order of the lights is received from the above-mentioned outputs and it is sufficient that the members 20 to 26 arranged in connection with each light 1 to 7 for determining the operating state of the lights are connected to this output.

In the simplest and most advantageous embodiment of the invention, the processor in the testing unit measures current pulses that occur in the feeder line 9 and associates them with different lights on the basis of the timeslots. If a current pulse occurs during a certain timeslot, it can be interpreted as indicating that the light is in working order, but if there is no pulse, this light is interpreted as being defective. Examination of timeslots always begins from the activation pulse, in which case only current changes that occur in the line during a certain period after this pulse are significant. Interference or the like at other times cannot thus influence the measurement result. The operating state of each light connected to the light array is found out during one testing period, and thus testing can be performed several times to confirm the result before giving a failure alarm.

Several safety light arrays are typically connected to the safety light centre. Each of them can be tested in turn by means of the above-mentioned method. Information on the state of lights belonging to different arrays can be stored in the memory of the testing unit, from which they can be read by means of the display unit of the centre. When the testing unit detects a defect in a light, it can give a failure alarm. When the serviceman comes to check the centre, he sees the number of the array and the number of the light in the array where the defect was detected on the display of the centre. A defective light can be located accurately by means of a separate map provided with the location and identifiers of the lights.

As stated above, it is simplest to force the safety light centre to battery drive, in which case direct voltage is supplied to the lights during testing. In that case, it is easy to implement the activation pulse and the return pulses of the lights can be detected easily and reliably. The method of the invention could also be applied during conventional alternate current supply. In that case, the activation pulse and the return pulses from the safety lights would have to be implemented by modulating the supply voltage and current of the safety lights. The necessary means would thus be more complicated than in the case described above, where testing is performed during direct current supply. The idea of the invention could also be applied to this case, i.e. the fact that the lights are distinguished from one another or identified on the basis of the timeslot during which they give a response to an enquiry from the testing unit.

The method and system of the invention were described above by a few exemplary embodiments and it is to be understood that they can be modified in several ways without deviating from the scope defined in the appended claims and the inventive concept described above. The invention was illustrated only in connection with safety lights but it can naturally be applied in connection with any similar device array, provided that the devices are connected in parallel to the same electric circuit and information similar to that given on the operation of safety lights can be given on the operating state of such devices. Thus, a corresponding system could be used e.g. for collecting information on whether doors are locked or not. In general, all devices that are connected in parallel to the same electric circuit and on the operating state of which ON/OFF information is obtainable can be controlled by the method and system of the invention.

1. A method of collecting information on an operating state from several devices connected in parallel to an electric circuit, each of the devices being provided with members for receiving an enquiry about the operating state of the device via said electric circuit from a testing unit and for sending a message indicating the information on the operating state to the testing unit via said electric circuit in response to the enquiry sent from the testing unit, the method comprising the steps of:
sending a common enquiry about the operating state of the devices by the testing unit to all members arranged in connection with said devices as at least one pulse-like change in a voltage supplied to the devices via said electric circuit, and
sending a response by the members to the testing unit as a current pulse after a period specific to each device from the pulse-like change in the voltage supplied.

2. A method according to claim 1, wherein only the members in connection with devices having a pre-determined operating state send the response to the testing unit.

3. A method according to claim 1, wherein only the members in connection with devices having a pre-determined operating state of two feasible operating states send the response to the testing unit.

4. A method according to claim 1, wherein the members send their response as current pulses identical to one another.

5. A method according to claim 2, wherein the members send their response as current pulses identical to one another.

6. A method according to claim 3, wherein the members send their response as current pulses identical to one another.

7. A method according to claim 1, wherein the several devices comprise safety lights connected to an array of safety lights.

8. A method according to claim 1, wherein the members each comprise an RC delay circuit for determining the period specific to each device.

9. A method according to claim 1, wherein the members each comprise a microprocessor and a DIP switch for determining the period specific to each device.

10. A method according to claim 1 wherein the step of sending a common enquiry comprises the step of sending a common enquiry about the operating state of safety lights by the testing unit to all members arranged in connection with said safety lights as at least one pulse-like change in a voltage supplied to the safety lights via said electric circuit, and said step of sending a response comprises the step of sending a response by the members to the testing unit as a current pulse after a period specific to each safety light from the pulse-like change in the voltage supplied.

11. A system for collecting information on an operating state from several devices connected in parallel to an electric circuit, each of the devices being provided with members for receiving an enquiry about the operating state of the device via said electric circuit from a testing unit and for sending a message indicating the information on the operating state to the testing unit via said electric circuit in response to the enquiry sent by the testing unit, wherein:
the enquiry about the operating state of the devices sent by the testing unit comprises at least one pulse-like change in a voltage supplied to the devices via said electric circuit, the change being common to all members arranged in connection with said devices, and
each of said members comprises a circuit for sending a current pulse to the testing unit in response to the pulse-like change in the voltage supplied after a period specific to each of said members after said pulse-like change was received.

12. A system according to claim 11, wherein each of said members is arranged to send its response only if the device in connection with it has a pre-determined operating state.

13. A system according to claim 11, wherein the circuit for setting the period specific to each member comprises a microprocessor and a digital setting unit connected thereto.

14. A system according to claim 13, wherein the digital setting unit comprises a DIP switch.

15. A system according to claim 11, wherein the several devices comprise safety lights connected to the same array of safety lights.
